(19) United States
(12) Patent Application Publication
(10) Pub. No.: US 2023/0421945 A1
(43) Pub. Date: Dec. 28, 2023

(54) METHOD AND SYSTEM FOR ACOUSTIC PASSTHROUGH

(71) Applicant: Apple Inc., Cupertino, CA (US)

(72) Inventors: Prateek Murgai, San Francisco, CA (US); Jonathan D. Sheaffer, San Jose, CA (US); David M. Fischer, San Francisco, CA (US); John Woodruff, Santa Cruz, CA (US); Tony S. Verma, San Francisco, CA (US)

(21) Appl. No.: 18/339,914

(22) Filed: Jun. 22, 2023

Related U.S. Application Data
(60) Provisional application No. 63/355,523, filed on Jun. 24, 2022.

(51) Int. Cl. H04R 1/10; H04R 1/32; H04R 3/00; G10L 21/0208

(52) U.S. Cl. CPC H04R 1/1083; H04R 1/326; H04R 3/005; G10L 21/0208; H04R 2420/07; G10L 2021/02087

(57) ABSTRACT

A method performed by a first headset worn by a first user, the method includes the first headset performing noise cancellation on a microphone signal captured by a microphone of the first headset that is arranged to capture sounds within an ambient environment in which the first user is located. The first headset receives, from a second headset that is being worn by a second user who is in the ambient environment and over a wireless communication link, at least one sound characteristic generated by at least one sensor of the second headset and passing through select sounds from the microphone signal based on the received sound characteristic.

### CROSS-REFERENCE TO RELATED APPLICATION

This application claims the benefit of and priority to U.S. Provisional Patent Application No. 63/355,523, filed Jun. 24, 2022, which is hereby incorporated by this reference in its entirety.

### FIELD

An aspect of the disclosure relates to an audio system to pass through selected sounds to be heard by a user of the device. Other aspects are also described.

### BACKGROUND

Headphones are audio devices that include a pair of speakers, each of which is placed on top of a user's ear when the headphones are worn on or around the user's head. Similar to headphones, earphones (or in-ear headphones) are two separate audio devices, each having a speaker that is inserted into the user's ear. Both headphones and earphones are normally wired to a separate playback device, such as an MP3 player, that drives each of the speakers of the devices with an audio signal in order to produce sound (e.g., music). Headphones and earphones provide a convenient method by which the user can individually listen to audio content without having to broadcast the audio content to others who are nearby.

### SUMMARY

An aspect of the disclosure is a method performed by a first headset (e.g., in-ear headphones) worn by a first user. The first headset performs noise cancellation on a microphone signal captured by a microphone of the first headset that is arranged to capture sounds within an ambient environment in which the first user is located. For instance, the headset may produce an anti-noise signal from the microphone signal, which when used to drive one or more speakers of the headset reduces (or eliminates) the user's perception of one or more ambient sounds that is originating within the ambient environment. The headset receives, from a second headset that is being worn by a second user who is in the ambient environment and over a wireless communication link (e.g., a BLUETOOTH link), at least one sound characteristic generated by at least one sensor of the second headset. For example, the characteristic may include a voice profile of the second user's voice. The first headset passes through select sounds from the microphone signal based on the received sound characteristic. In particular, the first headset may perform an ambient sound enhancement (ASE) process that uses the second user's voice profile to produce a sound reproduction of the second user's speech (e.g., as an audio signal) from the microphone signal, and use the audio signal to drive a speaker of the first headset. Thus, the first headset is produces an acoustic refuge in which sounds of little or no interest to the user (e.g., ambient noise) is reduced (or eliminated), while other sounds that are of interest (e.g., speech of a second user who is in a vicinity of the first user) are heard by the first user.

In one aspect, the first headset spatially reproduces a virtual sound source while passing through the selected sounds. In some aspects, the virtual sound source is associated with a virtual ambient environment in which the first user and the second user are participating through their respective headsets. In another aspect, the first headset further selects the virtual ambient environment from a plurality of virtual ambient environments from which virtual sound sources are to be perceived by the first user as originating based on user input of the first user into the first headset or of the second user into the second headset. In one aspects, the spatially reproduced virtual sound source is perceived by the first user and the second user as originating from a same position within the virtual ambient environment. In another aspect, the first headset further determines a spatial relationship between the first user and the second user within the ambient environment, wherein the virtual sound source is spatially rendered according to the spatial relationship. In one aspect, determining the spatial relationship comprises defining a common coordinate system between the first and second users based on a first location of the first user and a second location of the second user and an orientation of the first user with respect to the second user, wherein the spatially reproduced virtual sound source is positioned and orientated according to the common coordinate system.

In one aspect, the sound characteristic comprises a voice profile of the second user's voice, wherein passing through selected sounds comprises selecting, using the voice profile, speech of the second user from the microphone signal as a speech signal; and driving a speaker of the first headset with the speech signal. In another aspect, the sound characteristic comprises positional data that indicates a position of the second user, wherein the first headset further obtains a plurality of microphone signals from a plurality of microphones of the first headset; and produces a beamforming audio signal that includes speech of the second user using a beamforming process upon the plurality of microphone signals according to the positional data, wherein passing through the selected sounds comprises using the beamforming audio signal to drive one or more speakers of the first headset. In some aspects, the sound characteristic is produced by the second headset using one or more microphone signals captured by one or more microphones of the second headset and an accelerometer signal captured by an accelerometer of the second headset.

In one aspect, the first headset further determines whether the second headset is authorized to transmit the sound characteristic to the first headset, wherein the sound characteristic is received in response to determining that the second headset is authorized. In another aspect, determining whether the second headset is authorized comprises determining that the second headset is within a threshold distance from the first headset based on sensor data received from one or more sensors of the first headset; and in response, determining that an identifier associated with the second headset is within a list stored within the first headset.

In one aspect, the sound characteristic is received in response to determining that the second user is attempting to engage in a conversation with the first user based on sensor data. In another aspect, the sound characteristic is a first sound characteristic, wherein the first headset further receives receiving an accelerometer signal from an accelerometer of the first headset; and produces a second sound characteristic based on the accelerometer signal, wherein the selected sounds are based through based on the second characteristic.

According to another aspect of the disclosure, a first headset worn by a first user located in an ambient environment, the first headset comprising a microphone arranged to capture sounds form within the ambient environment as a microphone signal, a transceiver configured to receive a sound characteristic of the ambient environment that is captured by at least one sensor of a second headset worn by a second user located in the ambient environment, and a processor configured to perform noise cancellation on the microphone signal and pass through selected sounds from the microphone signal based on the received sound characteristics.

According to another aspect of the disclosure, a first headset worn by a first user located in an ambient environment, the first headset comprising: a transceiver configured to transmit a sound characteristic of the ambient environment to a second headset worn by a second user located in the ambient environment. For example, the first headset may include one or more sensors arranged to produce sensors data based on the environment, where the first headset may produce the sound characteristic based on the sensor data. The first headset may include a processor configured to perform noise cancellation on a microphone signal captured by the microphone; and pass through a selected sound from the microphone signal based on the sound characteristic.

In one aspect, the sound characteristic is a first sound characteristic, and the selected sound is a first selected sound, where the transceiver is further configured to receive a second sound characteristic of the ambient environment from the second headset, wherein the processor is further configured to pass through a second selected sound from the microphone signal based on the second sound characteristic. In another aspect, the second sound characteristic comprises a voice profile of the second user and the second selected sound comprises speech of the second user.

In one aspect, the processor is configured to generate, using the microphone signal, the sound characteristic that comprises at least one of identifying data and positional data of a sound source within the ambient environment. In another aspect, the first headset further includes several of microphones, wherein the processor generates the sound characteristic by using a beamformer signal that includes a directional beam pattern based on a plurality of microphone signals captured by the several microphones, where the directional beam pattern is directed towards the sound source. In one aspect, the sound characteristic is transmitted in response to determining that the first user is attempting to engage in a conversion with the second user.

The above summary does not include an exhaustive list of all aspects of the disclosure. It is contemplated that the disclosure includes all systems and methods that can be practiced from all suitable combinations of the various aspects summarized above, as well as those disclosed in the Detailed Description below and particularly pointed out in the claims. Such combinations may have particular advantages not specifically recited in the above summary.

### BRIEF DESCRIPTION OF THE DRAWINGS

The aspects are illustrated by way of example and not by way of limitation in the figures of the accompanying drawings in which like references indicate similar elements. It should be noted that references to “an” or “one” aspect of this disclosure are not necessarily to the same aspect, and they mean at least one. Also, in the interest of conciseness and reducing the total number of figures, a given figure may be used to illustrate the features of more than one aspect, and not all elements in the figure may be required for a given aspect.

FIGS. 1a and 1b show an example of an audio system with two headsets in which two users of the headsets enter an acoustic refuge in which ambient sounds are eliminated and select sounds are passed through each of the users' respective headsets according to one aspect.

FIG. 2 shows a block diagram of the audio system with at least two headsets according to one aspect.

FIG. 3 shows a block diagram of the audio system that produces an acoustic refuge by a first headset performing noise cancellation and passes through select sounds using sound characteristics received from the second headset according to one aspect.

FIGS. 4a and 4b are flowcharts of one aspect of a process for producing an acoustic refuge.

FIG. 5 is another flowchart of one aspect of a process for producing an acoustic refuge.

### DETAILED DESCRIPTION

Several aspects of the disclosure with reference to the appended drawings are now explained. Whenever the shapes, relative positions and other aspects of the parts described in a given aspect are not explicitly defined, the scope of the disclosure here is not limited only to the parts shown, which are meant merely for the purpose of illustration. Also, while numerous details are set forth, it is understood that some aspects may be practiced without these details. In other instances, well-known circuits, structures, and techniques have not been shown in detail so as not to obscure the understanding of this description. Furthermore, unless the meaning is clearly to the contrary, all ranges set forth herein are deemed to be inclusive of each range's endpoints.

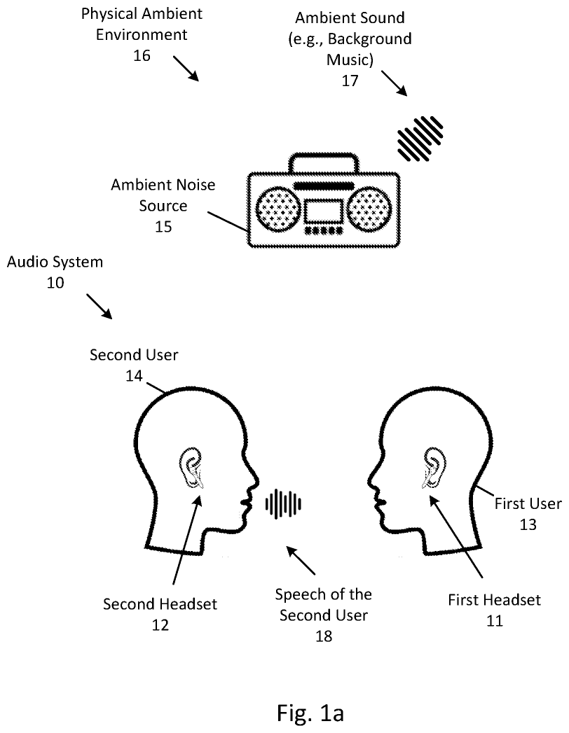

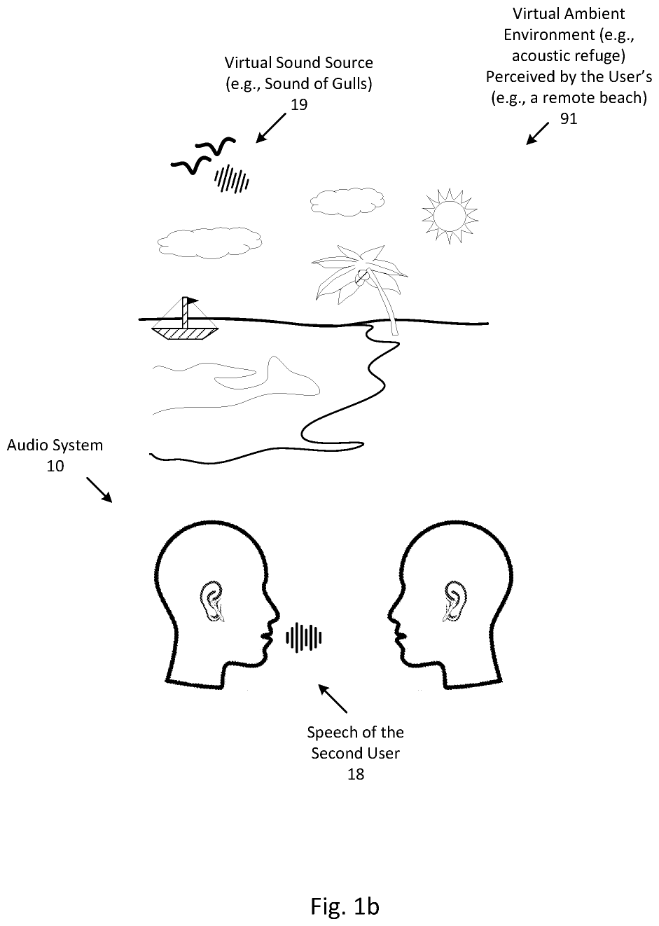

FIGS. 1a and 1b show an example of an audio system (or system) 10 with two headsets in which two users of the headsets enter an acoustic refuge in which (at least some) ambient sounds (such as ambient noises) that originate from the ambient (e.g., physical) environment are eliminated (or reduced), and select sounds may be passed through each (or at least one) of the users' respective headsets according to one aspect. Specifically, both figures show a first user 13 and a second user 14 talking to each other, where the first user is wearing (e.g., on the user's head) a first headset 11 and the second user is wearing a second headset 12. While talking to each other, both (or at least one of) the users enter an acoustic refuge in which their respective headsets cancel (or reduce) at least some ambient noises, while (e.g., contemporaneously) passing through other sounds (e.g., speech of the other user).

As illustrated, the headset 11 and the headset 12 are both in-ear headphones or earbuds that are designed to be positioned on (or in) a user's ears, and are designed to output sound into the user's ear canal. In some aspects, the earphone may be a sealing type that has a flexible ear tip that serves to acoustically seal off the entrance of the user's ear canal from an ambient environment by blocking or occluding in the ear canal. In one aspect, either of the headsets may be any type of (e.g., head-worn) electronic device that includes at least one speaker and is configured to output sound by driving that speaker. For instance, the headset 11 may be over-the-ear (or on-the-ear) headphones that at least partially cover the user's ears and are arranged to direct sound into the ears of the user.

In one aspect, although each headset is illustrated as including one in-ear headphone, each may include one or more headphones. For example, the first headset 11 may include two in-ear (e.g., wireless or wired) headphones, one for each ear, where each headphone may include similar electronic components (e.g., memory, processor(s), etc.) and may perform at least some of the operations described herein.

In some aspects, either or both of the devices may be any type of head-mounted device, such as smart glasses, or a wearable device, such as a smart watch. In some aspects, either of the devices may be any type of electronic device that is arranged to output sound into the ambient environment 16. Examples may include a stand-alone speaker, a smart speaker, a home theater system, or an infotainment system that is integrated within a vehicle. Other examples may include a tablet computer, a desktop computer, a smart phone, etc.

FIG. 1a shows a physical ambient environment 16 that includes the first user 13 wearing a first headset 11 and a second user 14 wearing a second headset 12, while both users are having a conversation (or more specifically, showing the second user speaking, as illustrated by showing a graphical representation of the second user's speech 18 coming out of the second user's mouth). The environment also includes an ambient noise source 15 (illustrated as a sound playback device), which is playing back noise (e.g., one or more ambient sounds), as background music 17. For example, the users may be in a public location, such as a restaurant, where music 17 is being played in the distance (e.g., to provide ambiance for customers). Although illustrated as a playback device, the noise source may be any type of sound source within the ambient environment 16 (e.g., which is not of interest to one or both of the users), such as other people talking, street noise, and/or sounds being produced by one or more speakers of other electronic devices (e.g., sound of a television, etc.).

Thus, as shown, the two users are having a conversation in a noisy environment (e.g., due to the ambient noise source 15 and/or other noise sources), which may be a harsh and taxing experience for both users (e.g., the second user 14 may have to repeat the speech 18 due to the first user 13 asking the second user to repeat themselves as a result of the ambient sound 17 drowning out the user's speech). Some headsets are capable of reducing ambient noise. For example, noise cancellation headphones may use anti-noise to cancel out sounds that leak into the user's ears (e.g., sound that is not eliminated due to any passive attenuation of the headset). Although effective, such a function may also cancel out (or reduce intelligibility) of user-interested sounds, such as the speech 18 of the second user 14. As a result, the use of noise cancellation capable headphones may acoustically isolate each of the user's further, which would make having a conversation, however, impractical.

To overcome these deficiencies, the present disclosure describes an audio system that is capable of producing a shared acoustic refuge (or space) in which users may interact with each other while collectively being isolated from their (e.g., common) ambient environment. For example, a (or each) headset (e.g., first headset 11) may perform acoustic noise cancellation (ANC) on a microphone signal captured by a microphone of the first headset that is arranged to capture sounds within the ambient environment in which the first user is located. In one aspect, the ANC may cancel most or all sounds. The headset 11 may receive, from the second headset 12, at least one sound characteristic generated using at least one sensor of the second headset. For instance, the characteristic may be a voice profile of the second user's speech. The first headset may pass through select sounds, such as the speech 18 of the second user 14, from the microphone signal based on the characteristic. In one aspect, both headsets may perform at least some of these operations such that sounds originating from within the physical environment are eliminated, whereas sounds that both users are interested in (each other's speech) are passed through each of the user's respective headset.

In one aspect, the acoustic refuge may also provide a shared virtual acoustic space in which both users may be (e.g., acoustically) isolated (e.g., from the ambient environment), where they can have their conversation in a more shared manner at the same time as being isolated from the noisy environment. Specifically, the audio system may be configured to isolate the users from the real ambience within the physical environment, while entering (e.g., perceiving) a virtual favorable ambience such that both users may perceive having their conversation in a given environment. FIG. 1b illustrates an example of the users 13 and 14 having a conversation while perceiving a virtual ambient environment (e.g., as the acoustic refuge). In particular, each of the users may perceive this acoustic refuge while remaining within the physical environment 16, which includes the undesirable ambient sound 17. Specifically, each of the user's headsets may be (acoustically) producing the virtual ambient environment of a (e.g., isolated) beach 91. In one aspect, the virtual ambient environment may be spatially reproduced by one or both of the headsets, such that one or more sound sources may be added within the virtual environment and perceived by the users as originating from one or more locations (e.g., in the environment 16 with respect to the users). For instance, each of the user's headsets may be spatially reproducing a virtual sound source 19 of a sound of gulls off in the distance, which may be perceived by both users as originating at a particular location within the physical environment 16 (e.g., at a location where the ambient noise source 15 is located). In some aspects, the acoustic refuge may include more diffuse sound sources, such as one or more sound beds associated with the environment (e.g., crashing of waves, a breeze, etc.) to provide a more immersive experience. Thus, both of the headsets may cancel the ambient noise 17 being produced by the source 15 as shown in FIG. 1a, while spatially reproducing virtual sound sources of the virtual ambient environment. As a result, both of the users may share the virtual acoustic refuge as if having a conversation on a beach, while remaining within the (e.g., restaurant of the) physical environment 16, which may be more appealing to both users than having a conversation at a busy restaurant that has loud music playing in the background.

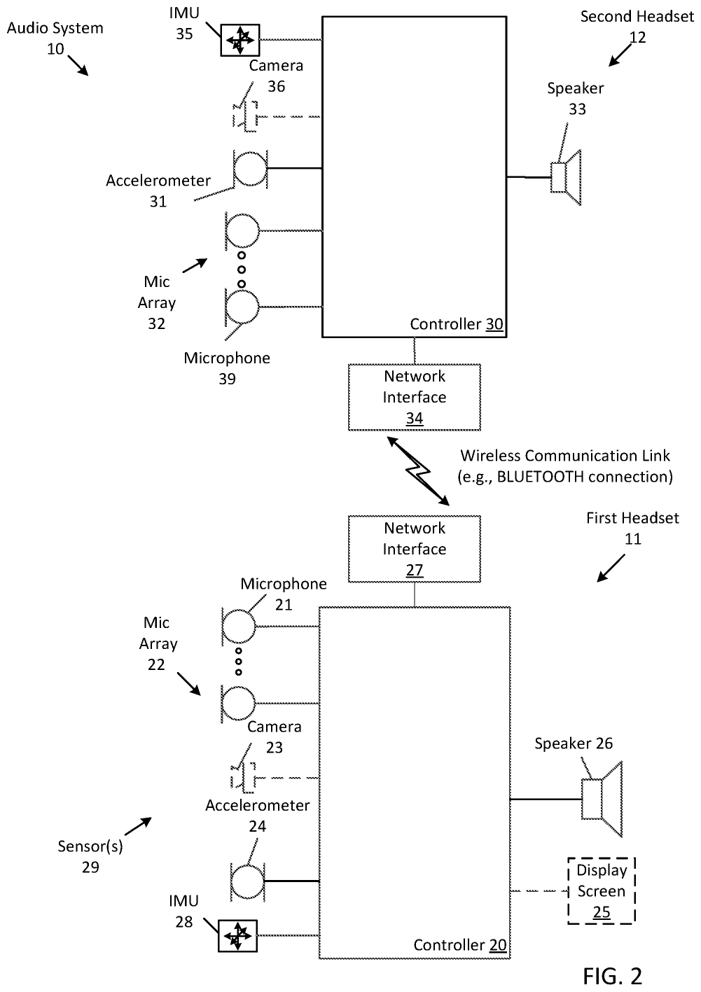

FIG. 2 shows a block diagram of the audio system 10 with headsets 11 and 12 that are configured to produce (e.g., conduct) an acoustic refuge, according to one aspect. The first headset 11 includes a controller 20, a network interface 27, a speaker 26, a display screen 25, and one or more sensor(s) 29 that include a microphone (or “mic”) array 22 with one or more microphones 21, a camera 23, an accelerometer 24, and an inertial measurement unit (IMU) 28. In one aspect, the headset 11 may include more or less elements, as shown herein. For example, the headset 11 may include two or more cameras, speakers, and/or display screens, or may not include the screen 25 (e.g., which may be the case when the headset 11 is an in-ear headphone).

The network interface 27 can communicate with one or more remote devices and/or networks. For example, the interface can communicate over a wireless communication link via one or more known technologies, such as WiFi, 3G, 4G, 5G, BLUETOOTH, ZigBee, or other equivalent technologies. In some aspects, the interface includes a transceiver (e.g., a transmitter/receiver) that is configured transmit and receive (e.g., digital and/or analog) data with networked devices such as servers (e.g., in the cloud) and/or other devices, such as the headset 12 (e.g., via the network 34). In another aspect, the interface may be configured to communicate via a wired connection.

The controller 20 may be a special-purpose processor such as an application-specific integrated circuit (ASIC), a general-purpose microprocessor, a field-programmable gate array (FPGA), a digital signal controller, or a set of hardware logic structures (e.g., filters, arithmetic logic units, and dedicated state machines). The controller is configured to perform audio signal processing operations and/or networking operations. For instance, the controller 20 may be configured to produce an acoustic refuge in which at least some ambient sounds are actively cancelled while at least some other sounds are passed through, such that the first user 13 may perceive the sounds in an isolated virtual environment. More about the operations performed by the controller 20 is described herein.

In one aspect, the one or more sensor(s) 29 are configured to detect the environment (e.g., in which the headset 11 and headset 12 are located) and produce sensor data based on the environment. For instance, the camera 23 may be a complementary metal-oxide-semiconductor (CMOS) image sensor that is capable of capturing digital images including image data that represent a field of view of the camera, where the field of view includes a scene of an environment in which the headset 11 is located. In some aspects, the camera may be a charged-coupled device (CCD) camera type. The camera is configured to capture still digital images and/or video that is represented by a series of digital images. In one aspect, the camera may be positioned anywhere about/on the headset (e.g., such that the field of view of the camera is directed towards a front of the user 13 while the headset is being worn). In some aspects, the device may include multiple cameras (e.g., where each camera may have a different field of view).

The microphone 21 may be any type of microphone (e.g., a differential pressure gradient micro-electro-mechanical system (MEMS) microphone) that is configured to convert acoustical energy caused by sound wave propagating in an acoustic environment into an input microphone signal. In some aspects, the microphone may be an “external” (or reference) microphone that is arranged to capture sound from the acoustic environment. In another aspect, the microphone may be an “internal” (or error) microphone that is arranged to capture sound (and/or sense pressure changes) inside a user's ear (or ear canal). In one aspect, each of the microphones of the microphone array 22 may be the same type of microphone (e.g., each being an external microphone). In another aspect, at least some of the microphones may be external and some may be internal.

The IMU 28 is configured to produce motion data that indicates the position and/or orientation of the headset. In one aspect, the headset may include additional sensors, such as (e.g., optical) proximity sensors that are designed to produce sensor data that indicates an object is at a particular distance from the sensor (and/or the local device). The accelerometer 24 is arranged and configured to receive (detect or sense) speech vibrations that are produced while a user (e.g., who may be wearing the output device) is speaking, and produce an accelerometer signal that represents (or contains) the speech vibrations. Specifically, the accelerometer is configured to sense bone conduction vibrations that are transmitted from the vocal cords of the user to the user's ear (ear canal), while speaking and/or humming. For example, when the audio output device is a wireless headset, the accelerometer may be positioned anywhere on or within the headphone, which may touch a portion of the user's body in order to sense vibrations.

In one aspect, the sensors 29 may be a part of (or integrated into) the headset (e.g., being integrated into a housing of the headset). In another aspect, sensors may be separate electronic devices that are communicatively coupled (via the network interface 27) with the controller. Specifically, when one or more sensors are separate devices, the first headset may be configured to establish a communication link (e.g., wired and/or wireless link) with the one or more sensors, via the network interface 27 for receiving sensor data.

The speaker 26 may be an electrodynamic driver that may be specifically designed for sound output at certain frequency bands, such as a woofer, tweeter, or midrange driver, for example. In one aspect, the speaker may be a “full-range” (or “full-band”) electrodynamic driver that reproduces as much of an audible frequency range as possible. In some aspects, when the headset includes two or more speakers, each of the speakers may be the same (e.g., full-range) or may be different (e.g., one being a woofer and another being a tweeter).

The display screen 25 (which is optional) is designed to present (or display) digital images or videos of video (or image) data. In one aspect, the display screen may use liquid crystal display (LCD) technology, light emitting polymer display (LPD) technology, or light emitting diode (LED) technology, although other display technologies may be used in other aspects. In some aspects, the display may be a touch-sensitive display screen that is configured to sense user input as input signals. In some aspects, the display may use any touch sensing technologies, including but not limited to capacitive, resistive, infrared, and surface acoustic wave technologies.

The second headset 12 includes a controller 30, a network interface 34, a speaker 33, a microphone array 32 that includes one or more microphones 39, an accelerometer 31, a (optional) camera 36, and an IMU 35. Although illustrated as having less elements, the second headset may include the same (e.g., number and/or type of) elements as the first headset 11 (e.g., which may be the case when both headsets are the same type of headset produced by the same manufacturer). In another aspect, either of the headsets may have more or less elements as shown herein, such as the second headset having a display screen. In one aspect, the controller 30 may be configured to perform at least some of the operations performed by the controller 20, such that the second headset 12 may produce (e.g., while being worn) an acoustic refuge for the second user 14.

As shown, both headsets are in wireless communication with each other via a wireless communication link (e.g., BLUETOOTH connection). For example, the network interface 27 may be configured to establish a communication link with (e.g., the network interface 34 of) the second headset, and once established exchange digital data, as described herein. In one aspect, the communication link may be established over a computer network, which may be any type of computer network, such as a wide area network (WAN) (e.g., the Internet), a local area network (LAN), etc., through which the devices may exchange data between one another and/or may exchange data with one or more other electronic devices. In another aspect, the network may be a wireless network such as a wireless local area network (WLAN), a cellular network, etc., in order to exchange digital (e.g., audio) data. With respect to the cellular network, the first headset may be configured to establish a wireless (e.g., cellular) call, in which the cellular network may include one or more cell towers, which may be part of a communication network (e.g., a 4G Long Term Evolution (LTE) network) that supports data transmission (and/or voice calls) for electronic devices, such as mobile devices (e.g., smartphones). In another aspect, the headsets may be configured to wirelessly exchange data via other networks, such as a Wireless Personal Area Network (WPAN) connection. For instance, the first headset may be configured to establish a wireless connection with the second headset via a wireless communication protocol (e.g., BLUETOOTH protocol or any other wireless communication protocol). During the established wireless connection, the headsets may exchange (e.g., transmit and receive) data packets (e.g., Internet Protocol (IP) packets) with the digital data, such as audio data (e.g., of user-desired audio content) for playback and/or may include one or more sound characteristics, as described herein.

In one aspect, at least some of the operations described herein that are performed by either of the controllers 20 and 30 may be implemented in software (e.g., as instructions stored in memory and executed by either controller) and/or may be implemented by hardware logic structures as described herein.

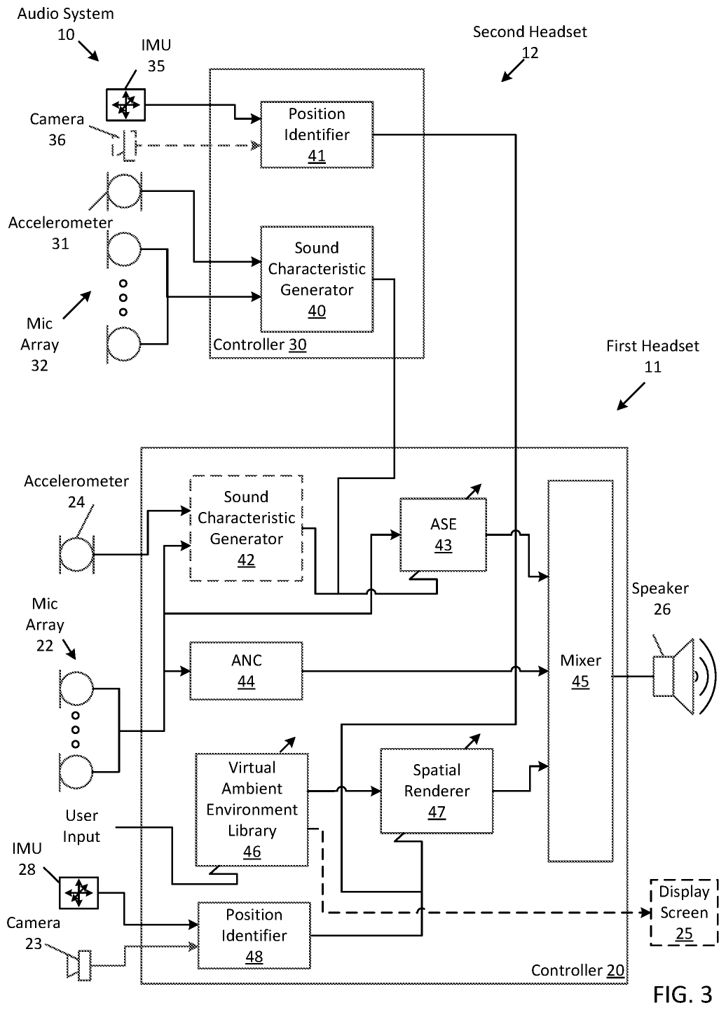

FIG. 3 shows a block diagram of the audio system 10 with a first headset 11 that produces an acoustic refuge by (at least one of) performing noise cancellation and passing through select sounds using sound characteristics received from the second headset 12, according to one aspect. As shown, the both controllers 20 and 30 include one or more operational blocks for (engaging) and producing an acoustic refuge for the users of those respective devices. Specifically, the controller 30 includes a sound characteristic generator 40 and a position identifier 41. In one aspect, the system may be configured to produce the acoustic refuge in response to determining that at least one of the users (e.g., of the first and second devices) is attempting to engage in a conversation with the other user in order to minimize any negative impact noise within the environment may have upon their conversation. More about determining whether a user is attempting to engage in a conversation is described herein.

The sound characteristic generator 40 may be configured to receive one or more microphone signals of the microphone array 32 and/or receive an accelerometer signal from the accelerometer 31, and is configured to use at least some of the (e.g., audio) data associated with the signals to generate one or more sound characteristics that may be associated with the second user 14 of the second headset and/or may be associated with sounds from the ambient environment. For example, the generator may produce a voice profile as a sound characteristic, which may (e.g., uniquely) identify the voice of the second user. In one aspect, the generator may (at least) use the accelerometer signal to produce the voice profile. For instance, the accelerometer may be less sensitive to acoustic sounds (e.g., sound that does not originate from the second user), while at the same time being more sensitive to speech vibrations (e.g., when the second headset is worn by the second user). Thus, the generator may use (e.g., at least some spectral content of) an accelerometer signal produced by the accelerometer 31 to produce a voice profile, which defines one or more voice parameters of the user, such as tone and pitch. In one aspect, the voice profile may be a spectral (or impulse) response that is uniquely associated with the second user 14. In some aspects, in addition to (or in lieu of) using the accelerometer signal, the generator may use one or more microphone signals to generate the voice profile. For example, the generator may use (similar or different) spectral content from the accelerometer signal and microphone signals to produce the voice profile. In another aspect, the generator may use any (e.g., known) method to produce the voice profile.

In one aspect, the voice profile may be in the form of a hash value. In particular, the generator may be configured to apply a cryptic hash function to the voice profile (e.g., information relating to the second user's voice, as described herein) and produce a hash value, which may be used to uniquely identify the voice of the second user (e.g., by the first headset to identify the second user's voice in one or more microphone signals).

In another aspect, the sound characteristics may include identifying data of one or more sound sources (e.g., a position of at least a portion of the second user, such as the second user's head) within the physical ambient environment 16. Specifically, the generator may use one or more microphone signals of the microphone array 32 to generate one or more sound characteristics of one or more sound sources. In particular, the microphones may be used to identify a sound source and its location (as sound source positional data), with respect to the second headset. For example, the generator may include a sound pickup microphone beamformer that is configured to process two or more microphone signals produced by two or more microphones of the array 32 to form at least one directional beam pattern in a particular direction, so as to be more sensitive to a sound source in the environment. The generator may use the beamformer to identify a sound source and the position of the sound source. For instance, the beamformer may use any method, such as time delay of arrival and delay and sum beamforming to apply beamforming weights (or weight vectors) upon one or more microphone signals to produce the beamformer signal that includes a directional beam pattern that may be directed towards a (e.g., identified) sound source. In one aspect, using the beamformer signal, the generator may identify the sound source (e.g., using spectral content of the signal to perform a table lookup into a data structure that associates spectral content with (pre)identified types of sources, or using any sound identification process). In another aspect, the generator may use any (known) method to identify the type of sound source, as the identifying data. In addition to (or in lieu of) identifying the sound source, the generator may determine the positional data of the sound source (e.g., with respect to the headset) using the directional beam pattern.

In another aspect, the generator 40 may employ other audio processing methods (e.g., upon one or more microphone signals and/or upon one or more beamformer signals) to identify the position of a sound source. For example, to identify the position of a sound source, the generator may employ sound source localization algorithms (e.g., based on the time of arrival of sound waves and the geometry of the microphone array 32). In another example, the generator may use a blind source separation algorithm to identify the sound source and the position of the sound source within the environment. From the identification of the sound source and its position, the generator may produce the (identifying data as the) sound characteristics of the source.

In some aspects, the generator 40 may produce additional sound characteristics of the environment. For instance, the generator may process one or more microphone signals to determine a signal-to-noise ratio (SNR), which may indicate an amount of noise within the environment. In another aspect, the generator may determine room acoustics of the physical environment, such as a sound reflection value, a sound absorption value, an impulse response for the environment, a reverberation decay rate of time, a direct-to-reverberation ratio, a reverberation measurement, or other equivalent or similar measurement. In some aspects, the generator may produce sound characteristics that indicate characteristics of noises within the ambient environments.

The position identifier 41 is configured to determine position data that indicates a position and/or orientation of the second headset (e.g., with respect to a reference point, such as a location of the first headset 11 or a reference point in relation to both headsets) within the physical ambient environment 16. In particular, the identifier 41 may receive data from the IMU that indicates a position and/or orientation of the second headset (e.g., with respect to a reference point). In another aspect, the identifier may determine the position of the second headset with respect to one or more objects within the environment. For instance, the identifier may receive image data from the camera 36, and may determine its position through the use of computer vision. In some aspects, the identifier may determine the position of the headset with respect to one or more other objects, such as the first headset. In particular, the computer vision may use triangulation in which the position of the headset is determined, given projections onto two or more digital images captured by the camera, relative to a known position of the second headset and/or orientation when the images were captured. In another aspect, the second headset may determine the position of the second headset through other means. For instance, the identifier may determine the position of the second headset with respect to the first headset based on a received signal strength indicator (RSSI) of a wireless connection between the two devices.

In another aspect, the position identifier 41 may determine the position of the second headset through other means. For example, the second headset may include a Global Positioning System (GPS) sensor (not shown) that may produce data that indicates a position of the second headset.

In one aspect, the second headset 12 is configured to transmit (at least some of) the sound characteristics that are generated using at least one sensor of the second headset. In particular, the second headset transmits characteristics produced by the generator 40 and/or the positional data of the position identifier 41 to the first headset 11 (e.g., via an established communication link). In some aspects, the second headset may encrypt (or encode) at least a portion of the transmitted data to the first headset in order to prevent others (or unauthorized persons) from accessing the data. Upon receiving the encrypted data, the (e.g., controller 20 of the) first headset may be configured to decrypt the data. In one aspect, any encryption algorithm (e.g., Advanced Encryption Standard (AES), etc.) may be used to encrypt (and decrypt) the data that is exchanged between the devices.

In one aspect, the second headset 12 may be configured to produce the sound characteristics and/or positional data periodically (e.g., at least once over a period of time). Specifically, the sound characteristic generator 40 may be configured to produce a voice print (or profile) of the second user at least once every day (e.g., every day analyzing at least the accelerometer signal and/or one or more microphone signals to produce the voice print). In some aspects, the generator may store (e.g., the encrypted) data on the second headset over a period of time, afterwards reproducing the data, as described herein. In another aspect, the second headset may produce the sound characteristics upon determining that the second user is attempting to engage (or has engaged) in a conversation with another user (such as the first user) and/or vice-a-versa. More about determining whether users are engaging in a conversation is described herein.

The controller 20 of the first headset 11 includes several operational blocks that are configured to produce an acoustic refuge with the second headset, as described herein. The controller 20 includes a sound characteristic generator 42, an ambient sound enhancement (ASE) 43, an acoustic noise cancellation (ANC) 44, a mixer 45, a virtual ambient environment library 46, a spatial renderer 47, and a position identifier 48. In one aspect, the second headset 12 may include at least some of similar or the same operational blocks as controller 20, and/or may be configured to perform at least some of the operations of the blocks, as described herein.

In one aspect, the position identifier 48 is configured to determine a position (e.g., as positional data) of the first headset 11. In some aspects, the identifier 48 may perform at least some of the operations described herein with respect to position identifier 41 of the second headset 12 for generating positional data associated with the first headset. For instance, the identifier 48 may use sensor data produced by the IMU 28 to determine an orientation of the first headset and/or a position of the headset, as the positional data. The sound characteristic generator 42 (which may be optional) is configured to produce one or more of the sound characteristics, as described herein. For instance, the generator 42 may be configured to use an accelerometer signal of the accelerometer 24 and/or one or more microphone signals of the microphone array 22 to produce a voice profile of the first user 13 of the first headset 11 and/or produce one or more voice profiles of other users, such as the second user 14. For example, as described thus far, the generators 40 and 42 of headsets 12 and 11, respectively, may be configured to produce voice profiles of the respective users. In another aspect, either of the generators may be configured to generate voice profiles of other users. For instance, the generator 42 may be configured to generate a voice profile of the second user of the second headset 12, and where the profile may be used to pass through speech of the second user.

The ANC 44 is configured to receive one or more microphone signals of the microphone array 22, and is configured to perform an (e.g., adaptive) ANC function to produce anti-noise from the microphone signals, which when played back by the speaker 26 reduces ambient noise from the environment (e.g., as perceived by the first user) that leaks into the user's ears (e.g., through a seal formed between the first headset and a portion of the first user's head). Thus, through the ANC, the controller performs noise cancellation on a microphone signal captured by microphone 21 that is an external microphone, to produce an anti-noise signal. The ANC function may be implemented as one of a feedforward ANC, a feedback ANC, or a combination thereof. In some aspects, the ANC may be an adaptive ANC. For example, the (e.g., feedforward) ANC receives (or obtains) a reference microphone signal produced from (or captured by) a microphone (e.g., microphone 21 of the array 22) that contains sound of an ambient environment in which a user wearing the headset is located. The ANC generate one or more anti-noise signals by filtering the reference microphone signal with one or more filters. In one aspect, the filter may be a finite-impulse response filter (FIR) or an infinite impulse response (IIR) filter.

The ASE 43 is configured to perform an ASE function for reproducing ambient sounds (e.g., captured by one or more microphones of the microphone array 22) in a “transparent” manner, e.g., as if the headset were not being worn by the user. The ASE is configured to receive one or more microphone signals (that contains ambient sounds from the environment 16) from the microphone array 22, and filter the signal(s) to reduce acoustic occlusion due to (e.g., a housing, such as a cushion or ear tip of) the headset (at least partially) covering the user's ear(s). In particular, the ASE may produce a filtered signal in which at least one sound of the ambient environment is selectively attenuated, such that the attenuated sounds are not reproduced by the speaker, and/or in which at least one sound is selectively passed through the headset (e.g., the sound being included in the filtered signal, which is passes through when playback back by the speaker). In one aspect, the ASE may fully attenuate (e.g., duck) one or more sounds, or the sounds may be partially attenuated such that an intensity (e.g., volume) of the sound is reduced (e.g., by a percentage value, such as 50%). For instance, the filters may reduce a sound level of the microphone signal.

In one aspect, the (e.g., one or more filters used by the) ASE may also preserve the spatial filtering effect of the wear's anatomical features (e.g., head, pinna, shoulder, etc.). In one aspect, the ASE may also help preserve the timbre and spatial cues associated with the actual ambient sound. Thus, in one aspect, the filter(s) of the ASE may be user specific according to specific measurements of the user's head. For instance, the system may determine the filter according to a head-related transfer function (HRTF) or, equivalently, head-related impulse response (HRIR) that is based on the user's anthropometrics.

In one aspect, the ASE may be configured to select and pass through sounds based on one or more sound characteristics received from the second (and/or first) headset(s). For example, the ASE may select, using the voice profile of the second user, speech of the second user from one or more microphone signals as a speech signal. In particular, the ASE may perform voice activity detection (VAD) operations to detect speech within the microphone signals, and then compare aspects of the speech (e.g., tone, spectral content, etc.) with the voice profile. For example, when the voice profile is a hash, the (e.g., sound characteristic generator 42 of the) controller 20 may produce a hash of speech detected within one or more microphone signals captured by the microphone array 22. In which case, the ASE 43 may compare the produced hash with the hash received from the second headset 12. Upon matching the speech with the voice profile (or determining that both hashes match up to a threshold, for example), the ASE may produce a speech signal that includes the detected speech, and the headset 11 may pass through the speech by driving the speaker 26 with the signal. More about driving the speaker is described herein.

In addition to (or in lieu of) passing through the speech of the second user, the ASE may be configured to pass through speech of the first user's own voice based on sound characteristics produced by the generator 42. For instance, along with eliminating most ambient sounds, the ANC may also reduce (e.g., the intelligibility) of the first user's own voice. Not hearing one's own voice may be distracting and may cause a person to speak louder. As a result, the ASE may be configured to use sound characteristics, such as a voice profile of the first user, to pass through the first user's own voice. In another aspect, the ASE may use sound characteristics (e.g., associated with the first user) produced by the generator 42 to selectively pass through the speech of the second user. In particular, the ASE may user the sound characteristics of the first user to reduce (or eliminate) speech of the first user from being passed through, whereas speech of the second user may be passed through, as described herein.

In one aspect, the controller 20 may be configured to form a directional beam pattern in the direction towards the second headset 12 in order to selectively capture the speech of the second user to be passed through as a beamformer signal. For instance, the controller 20 may receive positional data (e.g., from the position identifier 41), which may indicate a position of the second user (or the second headset 12). The controller 20 may receive one or more microphone signals captured by the microphone array 22 of the first headset 11, and may use positional data of the second headset that indicates a position of the second user (e.g., with respect to a reference point (e.g., a common reference point between the two headsets)), and produce a beamformer signal that includes speech of the second user. In particular, the controller 20 may produce a beamformer signal that includes the speech of the second user using a beamforming process upon the microphone signals according to the positional data. In one aspect, the ASE 43 may pass through the speech of the second user by using (at least a portion of) the beamformer signal to drive the speaker 26 of the first headset.

As described herein, the ASE 43 may be configured to pass through speech of the second user (e.g., using one or more sound characteristics received from the second headset). In another aspect, the ASE may pass through other ambient sounds from within the ambient environment, using sound characteristics. For example, the ASE may determine that the first user (headset) is moving (directed or is looking) towards a sound source within the physical environment (e.g., a radio) identified by the sound characteristics (e.g., based on positional data of the sound source with respect to a location of the first headset). In which case, the ASE may pass through sound of the sound source, as described herein. In which case, the headset 11 may pass through sounds from the ambient environment that may be of interest to the first user 13.

The virtual ambient environment library 46 includes one or more virtual ambient environments of which the first user (and/or one or more other users, such as the second user) is to perceive virtual sound sources as originating while conducting an acoustic refuge. Specifically, each of the virtual environments within the library 46 may provide a user with a virtual ambience, such as a virtual beach, concert hall, or forest. In one aspect, each of the virtual environments may include one or more virtual audio sources and/or one or more virtual sound beds that are each associated with a given environment, such as the virtual remote beach 91 of FIG. 1b that includes the sound of gulls as a virtual sound source 19. In one aspect, the virtual environment may include source (or audio) data (e.g., as one or more audio signals stored in one or more audio files) and may include positional data that indicates a position of the sounds (virtual sound sources) within the virtual environment 91 (e.g., with respect to a coordinate system associated with the environment. In some aspects, the sound bed may be a diffuse background noise, which in the case of the environment 91 may be the sound of wind and/or waves splashing.

As described thus far, the virtual ambient environment library may include one or more virtual ambient environments, where each virtual environment may include sounds (e.g., as audio data) associated with the environment and/or other (e.g., meta)data that describes the (e.g., positional data that indicates a position of the) sounds within the environment (e.g., as one or more data structures). In another aspect, the library may include image (video) data associated with virtual ambient environments. Returning to the example of FIG. 1b, the library may include a virtual remote beach 91 with a virtual source (e.g., sound of gulls 19) and may include image data of the beach (e.g., showing the beach with the palm tree and boat in the water). In one aspect, the first headset may be configured to use the image data to display a visual representation of the virtual ambient environment on the display screen 25. More about displaying the image data is described herein.

The virtual ambient environment library 46 may be configured to select a virtual ambient environment to be presented to the first user 13 of the first headset 11 (e.g., the virtual environment is selected from which virtual sound sources and/or virtual sound beds are to be perceived by the first user as originating from about the user). Specifically, the library may select the environment based on user input of the first user. For instance, the first headset may include an input device (e.g., a physical button, a graphical user interface (GUI) button on a touch-sensitive display screen, etc.) from which the user may select an ambient environment. The selection of the environment may be performed through other means, such as a voice command of the first user received by the microphone array 22. In another aspect, the user input may be received through another electronic device that is communicatively coupled with the first headset. For instance, an electronic device, such as a smart phone or tablet computer may be communicatively coupled with the first headset, where the device may receive user input from the first user. In response, the electronic device may (e.g., wirelessly) transmit the input to the first headset.

In some aspects, the selection of the environment may be based on user input received from the second user (e.g., via the second headset 12). For instance, the second headset may receive user input from the second user (e.g., as described herein), and in response, transmit the input to the first headset 11. As described thus far, the environment is selected in response to user input. In another aspect, the selection of the environment may be performed automatically (e.g., by the first headset 11). For example, the first headset may select the ambient library in response to determining that the second user is attempting to engage in a conversation with the first user. More about automatically selecting the virtual ambient environment is described herein.

As described herein, the ASE 43 may be configured to pass through one or more sounds of the environment, such as speech of the second user. In some aspects, the ASE may pass through sounds based on the selected virtual ambient environment. For example, the ASE may determine whether received sound characteristics indicate (e.g., identify) one or more sound sources within the physical environment that are associated with a selected virtual ambient environment. Returning to the example in FIG. 1b, the ASE may determine whether “beach” sounds (e.g., splashing water) are identified within the environment by the second headset. Upon identifying a sound, the ASE may pass through that sound, as described herein.

The spatial renderer 47 is configured to receive the (selected) virtual environment, which may include audio data (e.g., audio signals) of one or more virtual sound sources and/or sound beds, and sound source positional data that defines the location of the sounds, and is configured to spatially render the virtual sounds according to the positional data such that the virtual sounds are perceived by the first user as originating from locations within the physical environment. In particular, the renderer may apply one or more spatial filters the associated audio signals to produce spatially rendered audio signals. For example, the renderer may apply one or more head-related transfer functions (HRTFs), which may be personalized for the user in order to account for the user's anthropometrics. In this case, the spatial renderer may produce binaural audio signals, a left signal for a left speaker and a right signal for a right speaker of the headset, which when outputted through respective speakers produces a 3D sound (e.g., gives the user the perception that sounds are being emitted from a particular location within an acoustic space). In one aspect, when there are multiple virtual sound sources, the spatial renderer may apply spatial filters separately to each (or a portion of the sounds).

In some aspects, the spatial renderer may apply one or more other audio signal processing operations. For example, the renderer may apply reverberation and/or equalization operations. In particular, the renderer apply the reverberation based on the virtual ambient environment in which the users are to participate.

As described herein, the audio system 10 may be configured to produce an acoustic refuge in which both the first and second users may perceive a shared isolated virtual ambient environment, through their own respective headsets (e.g., while engaged in a conversation). In one aspect, the spatial renderer may be configured to spatially render the virtual ambient environment such that each user perceives a virtual sound as originating from a common location (or direction) within the physical environment. For example, the system may be configured to determine a spatial relationship between the users within the ambient environment, where the sounds are spatially rendered according to the relationship. In particular, the system may align the virtual ambient environment with a common (shared) world coordinate system, such that both users perceive virtual sounds as originating from a same location within the coordinate system (e.g., with respect to a shared reference point). In one aspect, the spatial renderer may produce (define) the common coordinate system between the first and second users based on positional data received from the identifier 41 of the second headset and positional data received from the identifier 48. In particular, the system may be defined between the users based on a location and orientation of the first user with respect to the second user and based on a location and orientation of the second user with respect to the first user. With the common coordinate system, the spatial renderer may spatially reproduce virtual sound sources positioned and orientated according to the common coordinate system. Specifically, the spatial renderer may determine a spatial filter (e.g., HRTF) to be applied to an audio signal of a virtual sound source based on the position of the sound source within the common coordinate system and with respect to the orientation of the first user.

In one aspect, the first headset may be configured to share the common coordinate system (e.g., as a data structure) with the second headset, such that the second headset may spatially render virtual sounds according to the same system. In another aspect, the spatial renderer may receive (at least a portion of) the common coordinate system from the second headset.

The mixer 45 is configured to receive audio data from the ASE 43, the ANC 44, and/or the spatial renderer 47, and is configured to perform mixing operations (e.g., matrix mixing operations, etc.) to produce one or more driver signals to drive the speaker 26. Specifically, the mixer may receive one or more filtered audio signals from the ASE that includes sounds from the physical environment that are selected to be passed through the headset, may receive an anti-noise signal from the ANC, and may receive spatially rendered audio signals from the spatial renderer that includes a spatial reproduction of a virtual ambient environment. In particular, the controller spatially reproduces at least one virtual sound source to create the virtual ambient environment of the acoustic refuge, which may be shared between the users, while passing through the selected sounds (e.g., the speech of the second user). As a result, the mixer produces a driver signal, which when used to drive the speaker produces an acoustic refuge in which most ambient sounds are reduced (or eliminated), at least one sound is passed through the headset (e.g., speech of the second user), and/or a virtual ambient environment is produced that includes one or more virtual sound sources and/or virtual sound bed.

As described thus far, the spatial renderer 47 may produce one or more spatially rendered audio signals, whereby the mixer 45 may receive the signals and may mix the signals with anti-noise from the ANC 44 and ASE signals from the ASE 43. In another aspect, the mixer 45 may perform spatially rendering operations, as described herein. For instance, the mixer 45 may apply one or more spatial filters (e.g., HRTF filters) upon one or more received signals and/or upon one or more mixed signals to produce one or more driver signals.

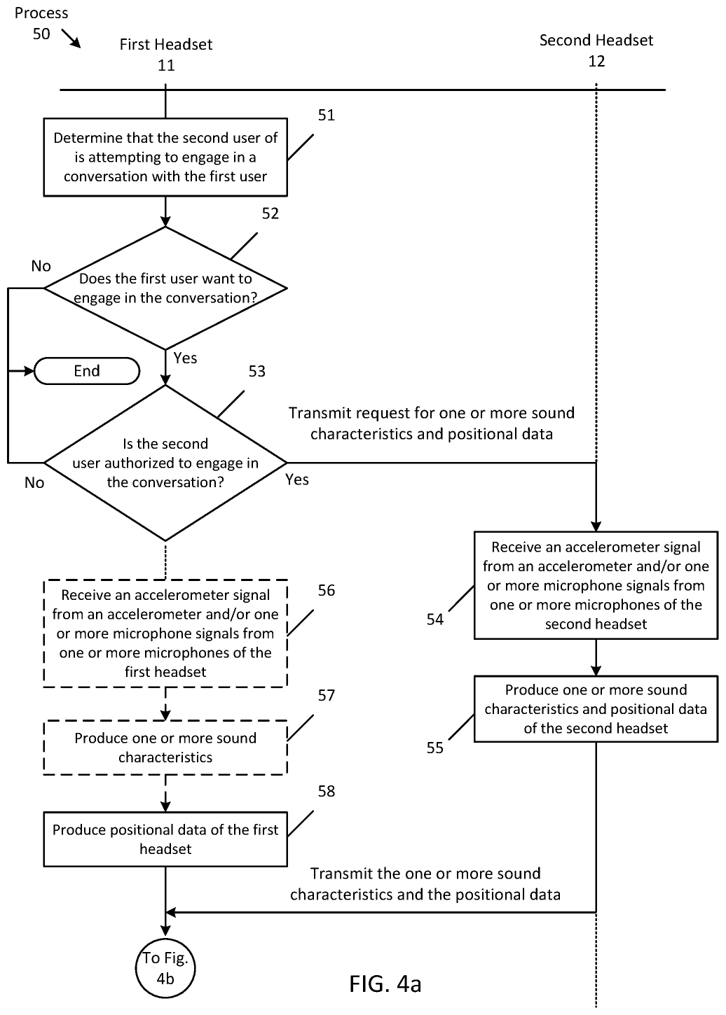

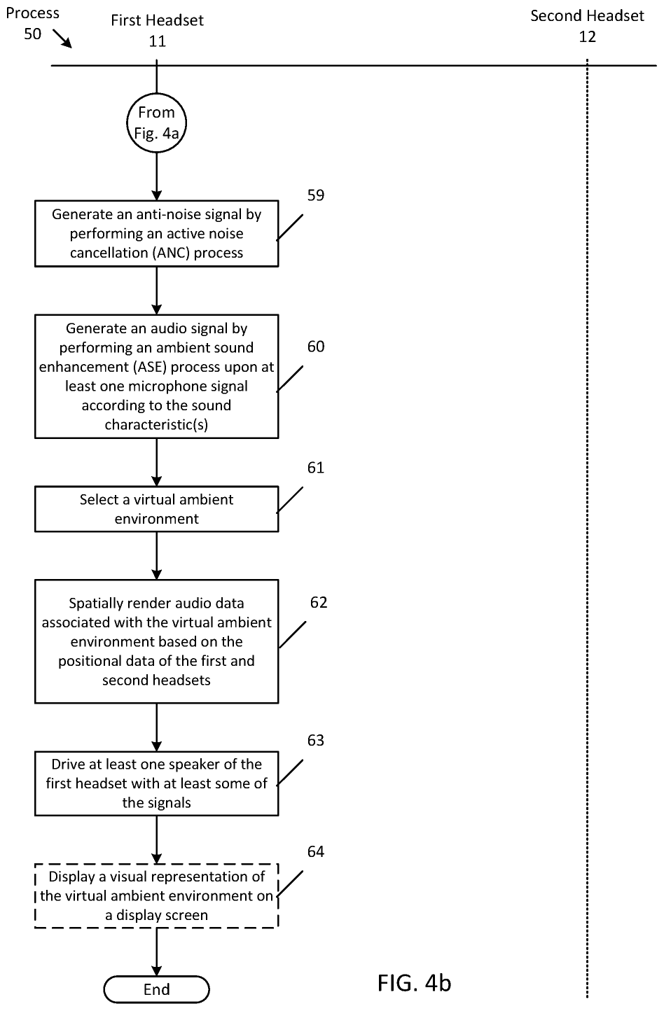

FIGS. 4a and 4b are flowcharts of one aspect of a process 50 for producing an acoustic refuge between two headsets (e.g., the first headset 11 and the second headset 12 of FIGS. 1a and 1b). In one aspect, at least a portion of the process may be performed by the (controller 30) of the second headset 12 and/or the (controller 20 of the) first headset 11. Specifically, at least some of the operations described herein may be performed by at least some of the operational blocks described in FIG. 3.

In one aspect, the process 50 describes operations performed by the first headset to produce an acoustic refuge in which at least some sounds of the ambient environment are reduced (or eliminated), at least some sounds of the environment are passed through for the first user to hear, and/or at least some virtual sounds of a virtual ambient environment are produced, based on sound characteristics and positional data of the second headset (and/or first headset). In another aspect, the second headset may be configured to perform at least some of these operations in order to produce a (e.g., similar or the same) acoustic refuge. In which case, when both headsets are performing these operations, both of their users may cohabitate a shared acoustic refuge such that users of the headset may be isolated within a virtual ambient environment and such that the users may both perceive a same virtual sound source within the shared environment (e.g., where the virtual sound source is spatially reproduced such that both users perceive the source as originating from a same position within the environment). In particular, both users may perceive the virtual sound source as originating from a same location (e.g., with respect to a reference point) within the physical environment in which both users are located.

The process 50 begins by the controller 20 of the first headset determining that the second user is attempting to engage in a conversation with the first user (at block 51). In one aspect, this determination may be based on sensor data of at least some of the sensors 29. For example, the controller 20 may receive image data captured by the camera 23 and perform an image recognition algorithm to identify one or more objects within a field of view of the camera that may indicate that the second user is attempting to engage in a conversation. For instance, the controller may determine that the second user is moving towards the first user, who is wearing the first headset 11. In another aspect, the controller may determine that the second user is within a threshold distance of the first headset (e.g., based on image data). In another aspect, the controller may determine that the second user is attempting to engage in a conversation based on identifying physical characteristics of the second user. For example, the controller may determine that the second user is gazing (looking) at the first user (for a period of time). As another example, the controller may determine that the second user is talking based on mouth movements identified within the image data.

In another aspect, the controller may determine that the second user wants to (or is engaging in) a conversation based on speech detected within one or more microphone signals captured by the microphone array 22. For example, the controller may perform VAD operations upon one or more microphone signals to detect a presence of speech. In particular, the controller may produce a VAD value based on the VAD operations, where when the VAD value is greater than a threshold, it may be determined that (another person besides the first user) is speaking within a threshold distance of the first user. In another aspect, may determine that the second user is speaking to the first user based on a SNR of the detected speech. For instance, when the SNR is greater than a threshold, it may mean that the user is speaking to (and close by) the first user.

The controller determines whether the first user wants to engage in the conversation with the second user (at decision block 52). For example, the controller may determine that the first user is speaking (e.g., based on an accelerometer signal captured by the accelerometer 31 being above a threshold). As another example, the controller may determine that first user wants to engage (or is engaging) in the conversion based on movements of the first headset. For instance, the controller may determine that the (e.g., front of) first headset has been reoriented towards a direction towards which the second user is located within the physical environment. This may be performed based on IMU position and orientation data. As another example, the controller may determine that the first user is moving towards the second user based on image data captured by the camera 23 and/or IMU data from the IMU 28. In another aspect, the controller may perform at least some of the same operations described in block 51 to determine whether the first user is attempting to engage in the conversation.

If so, the controller determines whether the second user is authorized to engage in the conversation (at decision block 53). In particular, the controller 20 determines whether the second headset is authorized to exchange (e.g., transmit and/or receive) data, such as sound characteristics and/or positional data, with the first headset 11 in order for the second user and the first user to engage in a conversation through an acoustic refuge. For instance, the controller may determine whether the second user (and/or second headset) is known to the first user (e.g., the first user's headset). Specifically, the controller may receive (e.g., in response to transmitting a request to the second headset) identifying information. For example, both devices may establish a wireless communication link, and the second headset may transmit the identifying information, which may include any type of information that identifies the second user and/or the second headset, such as a name of the second user, a telephone number associated with the second user, a model number of the second headset, and/or any type of unique identifier associated with the second user and/or second headset. Using the information, the first headset may determine whether the second headset is authorized. For example, the controller 20 may determine whether the second (e.g., user of the) headset is within a whitelist (e.g., as a data structure) that indicates devices and/or users that are authorized to exchange data (e.g., and/or engage in an acoustic refuge). As another example, the controller may determine whether the second user is within a contacts list of the first user (e.g., when the identifying information includes a name of the second user and/or includes a telephone number associated with the second user). Upon determining that the second user is within the whitelist (and/or contacts list), the second user may be authorized.

In another aspect, the controller may determine whether the second user is authorized based on previous interactions with the first user. For instance, the controller may determine whether the second user had previously (e.g., within a time period) engaged in a conversation with the first user (and had previously exchanged data). If so, the controller 20 may authorize the second headset. In another aspect, the controller may determine whether the first user has authorized the second headset. For example, the controller may present a notification (e.g., an audible alert) indicating to the first user that authorization is required to exchange data in order to produce an acoustic refuge. If approval is received (e.g., via a voice command, user input of an input device, etc.), the controller may authorize the second headset.

In one aspect, the controller 20 may determine whether the second headset is authorized in response to determining that either (or both) of the users are attempting to engage in a conversation. In particular, the controller may make this determination based on sensor data from one or more sensors (e.g., of the first headset). In another aspect, the controller may determine whether the second headset is authorized prior to (or during) the determination of whether the second headset is attempting to engage in a conversation. The controller may be configured to determine whether the second headset is within a threshold distance of the first headset based on sensor data. For example, the controller may determine the distance between the two headsets based on image data and/or wireless data, as described herein. As another example, the first headset may include a proximity sensor that may be arranged to determine distances of objects within the physical environment. In response to the second headset being within a threshold distance, the controller 20 may be configured to determine whether the second headset is authorized (e.g., by determining whether an identifier associated with the second headset (and/or second user) is within a (e.g., pre-authorized) list stored within the first headset).

If the second headset is authorized, the controller 20 transmits a request to the second headset for one or more sound characteristics and positional data. The (controller 30 of the) second headset receives an accelerometer signal from an accelerometer and/or one or more microphone signals from one or more microphones of the second headset (at block 54). In one aspect, the headset may receive these signals in response to receiving the request (e.g., thereby activating these components in response to the request). The controller 30 produces one or more sound characteristics and positional data of the second headset using at least some of the received signals (at block 55). As described herein, the controller 30 may use the accelerometer signal to produce a voice profile of the second user.

In one aspect, the first headset may perform some of the operations performed by the second headset to produce the sound characteristics and/or positional data. For instance, the controller 20 may receive an accelerometer signal from accelerometer 24 and/or one or more microphone signals from the microphone array 22 of the first headset (at block 56). The controller 20 may produce one or more sound characteristics of the first headset (at block 57). The controller 20 produces positional data of the first headset (at block 58). For instance, the position identifier 48 may identify the position and orientation of the first headset based on data from the IMU 28. In one aspect, at least some of these operations may be performed in response to the first headset transmitting the request to the second headset. In another aspect, the first headset may have previously performed these operations and stored the sound characteristics (e.g., a voice profile of the first user) in memory. In another aspect, at least some of these operations may be optional (e.g., operations performed in blocks 56 and 57), and therefore may not be performed by the first headset. With the sound characteristics and positional data produced, the second headset transmits this data to the first headset.

Turning to FIG. 4b, the process 50 continues by the controller 20 generating an anti-noise signal by performing an ANC process (at block 59). Specifically, as described herein, the ANC 44 may receive one or more microphone signals from one or more microphones of the array 22, and may perform the ANC process (e.g., feedback, feedforward, or a combination thereof) upon the microphone signals to produce the anti-noise signal, which when used to drive the speaker 26 reduces the user's perception of ambient noise (which may leak into the user's ear through the headset, as described herein). The controller generates an (filtered) audio signal by performing an ASE process upon at least one microphone signal according to one or more sound characteristics (at block 60). In particular, the ASE 43 may use a sound characteristic, such as a speech profile of the second user to generate the audio signal that includes speech of the second user captured by one or more microphones 22.

The controller 20 selects a virtual ambient environment for the acoustic refuge (at block 61). In particular, the virtual environment from which one or more virtual sound sources are to be perceived by the first user as originating based on user input of the first user or the second user. As described herein, the library 46 may receive a selection via user input of the first user or from the second user. In the case of the second user, the controller 20 may receive an indication of a user-selection of the environment (e.g., from the second headset 12 and/or from any electronic device of the second user 14, which may be communicatively coupled to the headset 12), and may use the indication to make a similar section by the library, in order to ensure that both devices are producing a similar (or the same) virtual ambient environment. The controller spatially renders the selected virtual ambient environment based on the positional data of the first and second headsets (at block 62). Specifically, the spatial renderer 47 produces a common world coordinate system using positional data (e.g., location and orientation) of both the first and second headsets, and then spatially renders (audio signals) of virtual ambient sound sources and/or sound beds of the virtual environment within that coordinate system to generate spatially rendered audio signals (e.g., binaural audio signals). For instance, the controller 20 may spatially reproduce a virtual sound source associated with a virtual ambient environment in which the first user 13 and/or the second user 14 are participating through their respective headsets.

The controller drives at least one speaker (e.g., speaker 26) of the first headset with at least some of the generated audio signals (at block 63). For instance, the controller may mix the anti-noise signal, the filtered audio signal and the spatially rendered signals and use the mix to drive the speaker 26. The controller (optionally) displays a visual representation (or presentation) of the virtual ambient environment on the display screen 25 (at block 64). Specifically, the controller may be configured to the environment as an extended reality (XR) environment (presentation) of the environment through one or more display screens of the first headset. As used herein, an XR environment (or presentation) refers to a wholly or partially simulated environment that people sense and/or interact with via an electronic device. For example, the XR environment may include augmented reality (AR) content, mixed reality (MR) content, virtual reality (VR) content, and/or the like. There are many different types of electronic systems that enable a person to sense and/or interact with various XR environments. Examples include head mountable systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers.

Thus, with the driving of the speaker(s) and displaying of the visual representation, the first headset produces the acoustic refuge, where the first user 13 may speak with the second user without hearing ambient noise and while perceiving a separate virtual ambient environment. As described herein, both headsets may be configured to perform (at least some of) the operations described in process 50 in order to allow users of both devices to participate in the same acoustic refuge (e.g., a remote beach, as shown in FIG. 1b). In another aspect, more than two electronic devices may perform these operations to participate in the same acoustic refuge. As a result, two or more users, each with an electronic device (such as a headset) may be able to participate in a common acoustic refuge.

In one aspect, the operations described herein to produce the acoustic refuge may be performed by both devices, while each of the devices transmit the sound characteristics and positional data to one another. In some aspects, the data exchanged between the devices may be small (e.g., below a threshold), thereby data to be transferred over low-energy wireless connections (e.g., BLUETOOTH low energy), while preserving low latency between the devices. By allowing the devices to transmit the data over low-latency, low-energy wireless connections, the spatial rendering of the acoustic refuge may be adapted (e.g., in real-time) to changes to the physical environment (e.g., the users moving with respect to each other).

Some aspects may perform variations to the process 50. For example, the specific operations of at least some of the processes may not be performed in the exact order shown and described. The specific operations may not be performed in one continuous series of operations and different specific operations may be performed in different aspects. For example, at least some of the operations may be omitted. In particular, as described herein, operations of blocks with dashed boundaries may be optional (e.g., blocks 56, 57, and/or 64).

In one aspect, at least some of the operations may be performed periodically (or continuously) during an engaged conversation (e.g., while the acoustic refuge is being produced). For instance, while the acoustic refuge is produced, the second (and first) headset may periodically produce the one or more sound characteristics and/or positional data of the headsets. In particular, the first headset may continuously receive new positional data in order to update spatial rendering of the virtual ambient environment. Similarly, the first headset may determine whether additional (or less) sound sources from which the physical environment are to be passed through based on the sound characteristics.

In some aspects, the controller may be configured to cease producing the acoustic refuge upon determining that either of the users have disengaged from the conversation. For example, the controller may determine whether the second user has walked away from the first user (e.g., based on image recognition of image data captured by the camera 23). In response, the controller may break down the communication link established between the two devices and cease transmitting (producing and receiving) sound characteristics and positional data.

As described thus far, the audio system 10 may produce an acoustic refuge in which at least some sounds are passed through the first (and second) headset(s), noise cancellation is performed, and an ambient virtual environment is produced. In another aspect, the audio system may not produce the ambient virtual environment. Instead, the headsets of the system may be configured to pass through certain sounds (e.g., speech), and cancel noise that originates within their shared physical environment. As a result, the acoustic refuge may create an isolated environment where users may speak (e.g., in private), such as a quiet room.

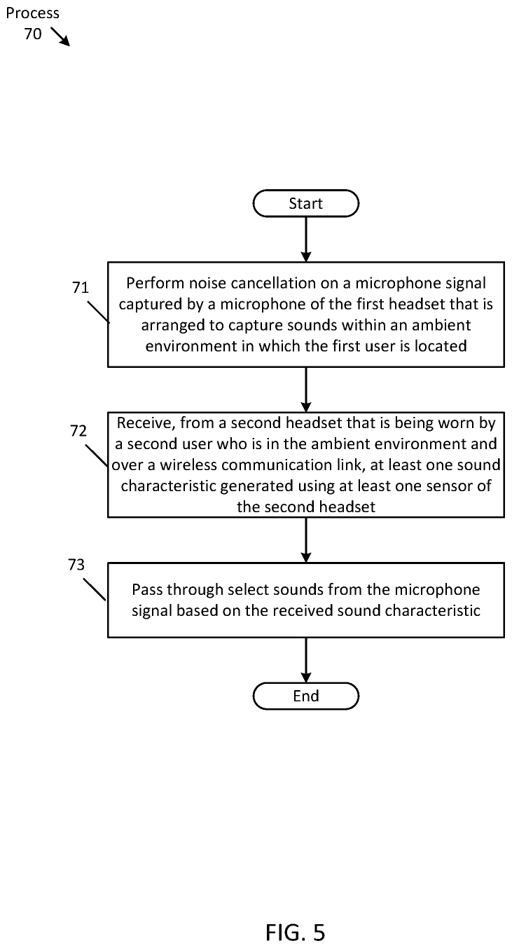

FIG. 5 is another flowchart of one aspect of a process 70 for producing an acoustic refuge. In one aspect, at least a portion of the operations of the process 70 may be performed by the controller 20 of the first headset 11 and/or performed by the controller 30 of the second headset 12. The process 70 begins by the controller 20 performing noise cancellation on a microphone signal captured by a microphone of the first headset that is arranged to capture sounds within an ambient (physical) environment in which the first user (and the first headset) is located (at block 71). The controller 20 receives, from a second headset that is being worn by a second user who is in the ambient environment and over a wireless communication link, a sound characteristic generated using at least one sensor of the second headset (at block 72). The controller passes through select sounds from the microphone signal based on the received sound characteristic (at block 73).

As described thus far, the first headset 11 may pass through selected sounds captured from a microphone based on sound characteristics received from the second headset 12. In another aspect, either of the devices may be configured to pass through sounds based on sound characteristics produced by each respective device. For example, the second headset 12 may transmit at least one sound characteristic to the first headset, and may pass through selected sounds based the sound characteristic produced and transmitted to the first headset. In another aspect, at least some of the operations performed by the second headset 12 may be based on a determination that the second user of the second headset may be attempting to engage in a conversion with the first user of the first headset 11. In some aspect, at least some of the operations described herein may be performed in order to pass through sounds using a device's own produced sound characteristics. In another aspect, the second device may also perform operations based on positional data of the headset.

In one aspect, a virtual sound source that is spatially reproduced by the first headset 11 is associated with a virtual ambient environment in which the first user and the second user are participating through their respective headsets. In another aspect, the controller 20 selects a virtual ambient environment from several environments (e.g., stored in memory) from which virtual sound sources are to be perceived by the first user as originating based on user input of the first user into the first headset or of the second user into the second headset. In one aspect, the controller receives positional data from the second headset that indicates a position of the second user; receives several microphone signals from the microphones of the first headset; and produces a beamformer signal that includes speech of the second user using a beamforming process upon the microphone signals according to the positional data, where passing through the selected sounds comprises using the beamformer signal to drive one or more speakers of the first headset. In one aspect, the sound characteristic is produced by the second headset using one or more microphone signals captured by one or more microphones of the second headset and an accelerometer signal captured by an accelerometer of the second headset. In another aspect, the controller 20 determines whether the second headset is authorized to transmit the sound characteristic to the first headset, where the sound characteristic is received in response to determining that the second headset is authorized. In one aspect, determining whether the second headset is authorized includes: determining that the second headset is within a threshold distance from the first headset based on sensor data received from one or more sensors of the first headset; and in response, determining that an identifier associated with the second headset is within a list stored within the first headset. In another aspect, the sound characteristic is a first sound characteristic, where the method further includes: receiving an accelerometer signal from an accelerometer of the first headset; and producing a second sound characteristic based on the accelerometer signal, where the selected sounds are based through based on the second characteristic.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

As previously explained, an aspect of the disclosure may be a non-transitory machine-readable medium (such as microelectronic memory) having stored thereon instructions, which program one or more data processing components (generically referred to here as a “processor”) to perform the network operations and audio signal processing operations, as described herein. In other aspects, some of these operations might be performed by specific hardware components that contain hardwired logic. Those operations might alternatively be performed by any combination of programmed data processing components and fixed hardwired circuit components.

While certain aspects have been described and shown in the accompanying drawings, it is to be understood that such aspects are merely illustrative of and not restrictive on the broad disclosure, and that the disclosure is not limited to the specific constructions and arrangements shown and described, since various other modifications may occur to those of ordinary skill in the art. The description is thus to be regarded as illustrative instead of limiting.

In some aspects, this disclosure may include the language, for example, “at least one of [element A] and [element B].” This language may refer to one or more of the elements. For example, “at least one of A and B” may refer to “A,” “B,” or “A and B.” Specifically, “at least one of A and B” may refer to “at least one of A and at least one of B,” or “at least of either A or B.” In some aspects, this disclosure may include the language, for example, “[element A], [element B], and/or [element C].” This language may refer to either of the elements or any combination thereof. For instance, “A, B, and/or C” may refer to “A,” “B,” “C,” “A and B,” “A and C,” “B and C,” or “A, B, and C.”

What is claimed is:

1. A method performed by a first headset worn by a first user, the method comprising:
performing noise cancellation on a microphone signal captured by a microphone of the first headset that is arranged to capture sounds within an ambient environment in which the first user is located;
receiving, from a second headset that is being worn by a second user who is in the ambient environment and over a wireless communication link, a sound characteristic generated using at least one sensor of the second headset; and
passing through a select sound from the microphone signal based on the received sound characteristic.

2. The method of claim 1 further comprising spatially reproducing a virtual sound source while passing through the selected sounds.

3. The method of claim 2, wherein the spatially reproduced virtual sound source is perceived by the first user and the second user through their respective headsets as originating from a same position within a virtual ambient environment.

4. The method of claim 1 further comprising:
determining a spatial relationship between the first user and the second user within the ambient environment; and
spatially rendering a virtual sound source based on the spatial relationship while passing through the selected sound.

5. The method of claim 4, wherein determining the spatial relationship comprises defining a common coordinate system between the first and second users based on a first location of the first user and a second location of the second user, wherein the spatially rendered virtual sound source is positioned and orientated according to the common coordinate system.

6. The method of claim 1, wherein the sound characteristic comprises a voice profile of the second user, wherein passing through selected sound comprises:
selecting, using the voice profile, speech of the second user from the microphone signal as a speech signal; and
driving a speaker of the first headset with the speech signal.

7. The method of claim 1, wherein the sound characteristic is received in response to determining that the second user is attempting to engage in a conversation with the first user based on sensor data.

8. A first headset worn by a first user located in an ambient environment, the first headset comprising:
a microphone arranged to capture sounds from within the ambient environment as a microphone signal;
a transceiver configured to receive a sound characteristic of the ambient environment that is captured by at least one sensor of a second headset worn by a second user located in the ambient environment; and
at least one processor configured to:
perform noise cancellation on the microphone signal; and
pass through a selected sound from the microphone signal based on the received sound characteristic.

9. The first headset of claim 8, wherein the first headset is further configured to spatially reproduce a virtual sound source while passing through the selected sounds.

10. The first headset of claim 9, wherein the spatially reproduced virtual sound source is perceived by the first user and the second user through their respective headsets as originating from a same position within a virtual ambient environment.

11. The first headset of claim 8, wherein the processor is configured to:
determine a spatial relationship between the first user and the second user within the ambient environment; and
spatially render a virtual sound source based on the spatial relationship while passing through the selected sounds.

12. The first headset of claim 11, wherein the processor is configured to determine the spatial relationship by defining a common coordinate system between the first and second users based on a first location of the first user and a second location of the second user and an orientation of the first user with respect to the second user, wherein the spatially rendered virtual sound source is positioned and orientated according to the common coordinate system.

13. The first headset of claim 8, wherein the sound characteristic comprises a voice profile of the second user, wherein the first headset passes through selected sounds by
selecting, using the voice profile, speech of the second user from the microphone signal as a speech signal; and
driving a speaker of the first headset with the speech signal.

14. The first headset of claim 8, wherein the sound characteristic is received in response to determining that the second user is attempting to engage in a conversation with the first user based on sensor data.

15. A first headset worn by a first user located in an ambient environment, the first headset comprising:
a transceiver configured to transmit a sound characteristic of the ambient environment to a second headset worn by a second user located in the ambient environment; and
a processor configured to
perform noise cancellation on a microphone signal captured by the microphone; and
pass through a selected sound from the microphone signal based on the sound characteristic.

16. The first headset of claim 15, wherein the sound characteristic is a first sound characteristic and the selected sound is a first selected sound, wherein the transceiver is further configured to receive a second sound characteristic of the ambient environment from the second headset, wherein the processor is further configured to pass through a second selected sound from the microphone signal based on the second sound characteristic.

17. The first headset of claim 16, wherein the second sound characteristic comprises a voice profile of the second user and the second selected sound comprises speech of the second user.

18. The first headset of claim 15, wherein the processor is configured to generate, using the microphone signal, the sound characteristic that comprises at least one of identifying data and positional data of a sound source within the ambient environment.

19. The first headset of claim 18 further comprises a plurality of microphones, wherein the processor generates the sound characteristic by using a beamformer signal that includes a directional beam pattern based on a plurality of microphone signals captured by the plurality of microphones, wherein the directional beam pattern is directed towards the sound source.

20. The first headset of claim 15, wherein the sound characteristic is transmitted in response to determining that the first user is attempting to engage in a conversion with the second user.
